(19) United States
(12) Patent Application Publication
(10) Pub. No.: US 2026/0105441 A1
(43) Pub. Date: Apr. 16, 2026

(54) REMOTE TRANSCEIVER LOCATION VERIFICATION

(71) Applicant: Truist Bank, Charlotte, NC (US)

(72) Inventors: Jamie Nathaniel Franklin, Charlotte, NC (US); Hayden Rebecca Thomas, Charlotte, NC (US)

(73) Assignee: Truist Bank, Charlotte, NC (US)

(21) Appl. No.: 18/911,866

(22) Filed: Oct. 10, 2024

(51) Int. Cl. G06Q 20/36

(52) U.S. Cl. CPC G06Q 20/367

(57) ABSTRACT

A computing system is configured to present, to a first transceiver of a first user, an interface of a transceiver platform prompting the first user to select a second user associated with a second transceiver for initiating an interaction between the first user and the second user via the transceiver platform and to determine a geographic location of the second transceiver via reference to a positioning device thereof. The computing system automatically communicates information regarding the determined geographic location of the second transceiver to the first transceiver prior to prompting the first user to make a selection regarding whether to complete the interaction between the first user and the second user, or automatically facilitates or cancels completion of the interaction between the first user and the second user based on analysis of the information regarding the determined geographic location of the second transceiver.

### FIELD

This invention relates generally to a digital payment platform for conducting wireless and electronic transactions, and more particularly, embodiments of the invention relate to a digital payment platform for conducting a wireless and electronic transaction that verifies the geographic location of one or more parties to the transaction as a security feature for ensuring that the desired parties are participating in the transaction.

### BACKGROUND

It is becoming increasingly common for individuals to utilize a digital payment platform, such as a smart device compliant software application operating as a mobile banking platform, for conducting wireless and electronic transactions. Specifically, such digital payment platforms provide the ability for the individual to quickly and efficiently conduct a transaction with another party via wireless access to the funds of the individual, wherein such funds may be associated with a bank account of the individual accessible via use of a corresponding mobile banking platform. Such transactions may include person-to-person payments, business-to-consumer payments, and government-to-consumer payments.

The use of such digital payment platforms may be especially beneficial when attempting to transfer funds with respect to certain relatively informal transactions, such as when an individual is attempting to split a shared cost with one or more additional parties or when the individual is paying another party back for a transaction conducted on the behalf of the individual. It has also become common for individuals to utilize such platforms when reselling certain items among non-business entities, such as when attempting to resell a used item via a local marketplace or auction-like service, as may be facilitated by the use of a social media platform.

The use of such digital payment platforms may typically include the payer logging into the account of the payer, as accessed via use of the digital payment platform, and then seeking the account of the payee via the entry of multiple forms of information identifying the payee, such as the payee's actual or (user selected) user name, the payee's telephone number, and/or the payee's email address. In other circumstances, the payer may be provided a list of existing payees from which to choose, wherein such a list may be generated via reference to a contact list of the payer that is associated with the payer's cell phone contact list or the payer's contacts originating from a social media platform or similar such listing of contacts.

One concern associated with the use of such digital payment platforms is that it is possible to accidentally select the incorrect payee when attempting to select the corresponding payee via the methods described above. For example, where the payer has multiple contacts with similar names and/or other similar identifying information, such as multiple contacts from the same family/surname or the same business entity, the payer may accidentally select the wrong payee and not realize the discrepancy when proceeding through the steps to finalize the payment. Such accidental payments can be time consuming and stressful to remedy as such accidental payments are not in and of themselves fraudulent, and hence the intent of all parties is not always readily evident when determining how to remedy such accidental payments.

Unfortunately, another common concern with such digital payment platforms relates to the manner in which these platforms have become a target of scammers utilizing a variety of different techniques in requesting what is often a non-refundable payment. Such scams may include the scammer contacting a target and promising some form of benefit upon completion of a payment, such as promising that employment may be available upon the payment for job-related equipment, or by stating that an especially lucrative sales price can only be appreciated if a down payment is made immediately and under duress. Other scams may include the scammer creating a fake account that closely mimics that of the target, whereby the scammer then convinces the target to make a payment to what the target believes is his or her own account as a step towards resolving some other concern. Many scams also exist wherein the scammer will impersonate bank personnel or the like while claiming that a problem with the account of the target can only be resolved via an upgrade in service or the immediate approval of a transfer of funds to an account supposedly associated with the bank or agent thereof in order to resolve some form of error in a supposedly quick and efficient fashion. As mentioned above, in many circumstances, such scam payments are interpreted by financial institutions as user-approved transactions that are not eligible for a quick and easy refund in the same manner as a fraudulent credit card payment, which contributes to the popularity of scammers targeting individuals via the use of such digital payment platforms.

There is accordingly a need for an efficient and effective system and method to aid in verifying the identity of those parties conducting such digital transactions in order to identify the existence of errors or fraud, and to further prevent the initiation of accidental or fraudulent payments that are subsequently difficult to reverse and/or resolve following completion thereof.

### BRIEF SUMMARY

Embodiments of the present invention address the above needs and/or achieve other advantages by providing apparatuses and methods that monitor and report the geographic location of a recipient of a transaction to a sender of the transaction to allow the sender to confirm the thoughts and impressions of the sender regarding the geographic location of the recipient for providing a security feature where suspect, fraudulent, or unauthorized transactions may be identified by the sender prior to completion of the transaction.

According to an embodiment of the present invention, a computing system for remote transceiver interaction includes at least one processor, a communication interface communicatively coupled to the at least one processor, and a memory device storing executable code that, when executed, causes the processor to present, to a first transceiver of a first user, an interface of a transceiver platform managed by the computing system. The interface prompts the first user to select a second user associated with a second transceiver for initiating an interaction between the first user and the second user via the transceiver platform. The executable code further causes the processor to determine a geographic location of the second transceiver via reference to a positioning device of the second transceiver and to automatically perform at least one of the following actions after the determining of the geographic location of the second transceiver associated with the second user: communicate information regarding the determined geographic location of the second transceiver to the first transceiver prior to prompting the first user to make a selection, via the interface of the transceiver platform, regarding whether to complete the interaction between the first user and the second user via the transceiver platform, or automatically facilitate or cancel completion of the interaction between the first user and the second user via the transceiver platform based on analysis of the information regarding the determined geographic location of the second transceiver.

According to another embodiment of the present invention, a method of operating a computing system for remote transceiver interaction includes the steps of: presenting, to a first transceiver of a first user, an interface of a transceiver platform managed by the computing system, the interface prompting the first user to select a second user associated with a second transceiver for initiating an interaction between the first user and the second user via the transceiver platform; determining a geographic location of the second transceiver via reference to a positioning device of the second transceiver; and automatically performing at least one of the following actions after the determining of the geographic location of the second transceiver associated with the second user: communicating information regarding the determined geographic location of the second transceiver to the first transceiver prior to prompting the first user to make a selection, via the interface of the transceiver platform, regarding whether to complete the interaction between the first user and the second user via the transceiver platform; or automatically facilitating or cancelling completion of the interaction between the first user and the second user via the transceiver platform based on analysis of the information regarding the determined geographic location of the second transceiver.

The features, functions, and advantages that have been discussed may be achieved independently in various embodiments of the present invention or may be combined in yet other embodiments, further details of which can be seen with reference to the following description and drawings.

### BRIEF DESCRIPTION OF THE SEVERAL VIEWS OF THE DRAWINGS

Having thus described embodiments of the invention in general terms, reference will now be made to the accompanying drawings, wherein:

FIG. 1 illustrates an enterprise system and environment thereof for engaging with a user during navigation of a mobile banking platform, in accordance with one embodiment of the present invention.

FIGS. 2-4 are exemplary displays of a mobile device illustrating a graphical representation of various subsequent interfaces of a digital payment platform during the steps of a sender selecting a recipient of a transaction including a monetary transfer, establishing the terms and conditions of the transaction, and requesting verification of a geographic location of the recipient prior to completion of the transaction.

FIG. 5 is an exemplary display of the mobile device illustrating a graphical representation of an interface of the digital payment platform relating to the selection by the sender of a recipient to a transaction with any geographic location information associated with each listed potential recipient displayed to the sender.

FIG. 6 is an exemplary display of the mobile device illustrating a graphical representation of an interface of the digital payment platform showing an alternative method of requesting verification of a geographic location of the recipient prior to completion of the transaction.

FIG. 7 is an exemplary display of the mobile device illustrating a graphical representation of an interface of the digital payment platform showing information relating to the geographic location of the recipient prior to completion of the transaction by the sender.

FIG. 8 is an exemplary display of the mobile device illustrating a graphical representation of an interface of the digital payment platform showing options available to the sender during the verification of the geographic location of the recipient.

FIG. 9 is an exemplary display of the mobile device illustrating a graphical representation of an interface of the digital payment platform showing options available to the sender following successful verification of the geographic location of the recipient where the determined geographic location of the recipient is not determined to include information indicative of a potentially fraudulent transaction or undesired recipient to the transaction.

FIG. 10 is an exemplary display of the mobile device illustrating a graphical representation of an interface of the digital payment platform showing options available to the sender following successful verification of the geographic location of the recipient where the determined geographic location of the recipient is determined to include information indicative of a potentially fraudulent transaction or undesired recipient to the transaction.

FIG. 11 is an exemplary display of the mobile device illustrating a graphical representation of an interface of the digital payment platform showing options available to the sender following unsuccessful verification of the geographic location of the recipient based on refusal of the location verification process by the recipient.

FIG. 12 is an exemplary display of the mobile device illustrating a graphical representation of an interface of the digital payment platform showing options available to the sender following unsuccessful verification of the geographic location of the recipient based on a timing out of the location verification process following inactivity by the recipient.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout. Unless described or implied as exclusive alternatives, features throughout the drawings and descriptions should be taken as cumulative, such that features expressly associated with some particular embodiments can be combined with other embodiments. Unless defined otherwise, technical and scientific terms used herein have the same meaning as commonly understood to one of ordinary skill in the art to which the presently disclosed subject matter pertains.

The exemplary embodiments are provided so that this disclosure will be both thorough and complete, and will fully convey the scope of the invention and enable one of ordinary skill in the art to make, use, and practice the invention.

The terms “coupled,” “fixed,” “attached to,” “communicatively coupled to,” “operatively coupled to,” and the like refer to both (i) direct connecting, coupling, fixing, attaching, communicatively coupling; and (ii) indirect connecting coupling, fixing, attaching, communicatively coupling via one or more intermediate components or features, unless otherwise specified herein. “Communicatively coupled to” and “operatively coupled to” can refer to physically and/or electrically related components.

Embodiments of the present invention described herein, with reference to flowchart illustrations and/or block diagrams of methods or apparatuses (the term “apparatus” includes systems and computer program products), will be understood such that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the herein described embodiments can be configured without departing from the scope and spirit of the invention. Therefore, it is to be understood that, within the scope of the included claims, the invention may be practiced other than as specifically described herein.

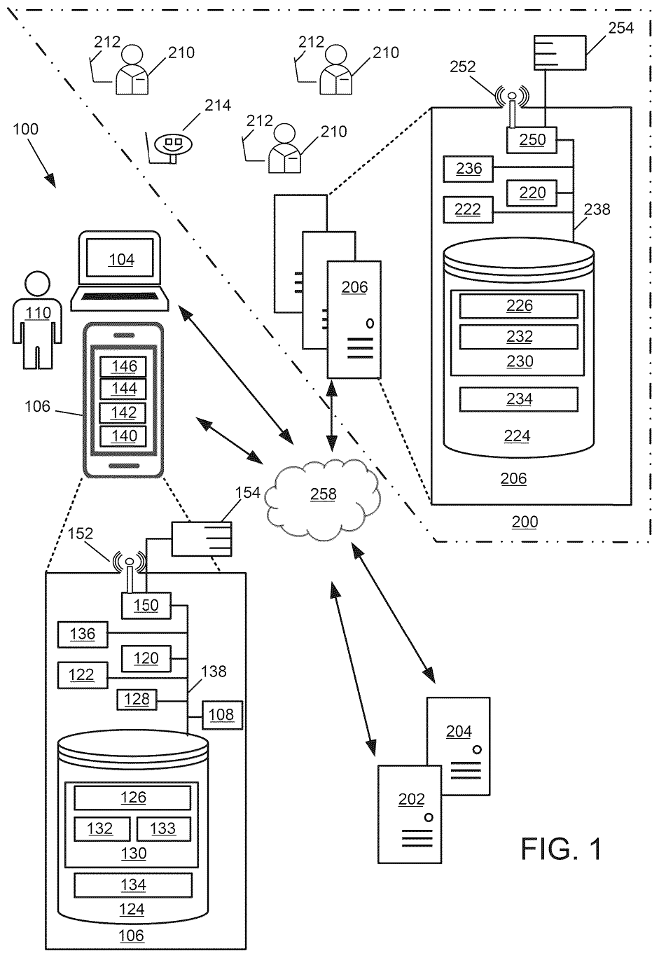

FIG. 1 illustrates a system 100 and environment thereof, according to at least one embodiment, by which a user 110 benefits through use of services and products of an enterprise system 200. The user 110 accesses services and products by use of one or more user devices, illustrated in separate examples as a computing device 104 and a mobile device 106, which may be, as non-limiting examples, a smart phone, a portable digital assistant (PDA), a pager, a mobile television, a gaming device, a laptop computer, a camera, a video recorder, an audio/video player, radio, a GPS device, or any combination of the aforementioned or other portable devices with processing and communication capabilities. In the illustrated example, the mobile device 106 is illustrated in FIG. 1 as having exemplary elements, the below descriptions of which apply as well to the computing device 104, which can be, as non-limiting examples, a desktop computer, a laptop computer, or other user-accessible computing device. That is, any references hereinafter to only the mobile device 106 may be considered to be inclusive of the computing device 104, wherein the primary differences between the mobile device 106 and the computing device 104 may relate to the manner in which such devices 104, 106 connect to an associated network and the corresponding system components included in each such device 104, 106 for making such network connections. For example, the computing device 104 may in some circumstances include the ability to form only a limited number of network connections via a relatively limited number or variety of different communication devices, methodologies, and/or protocols, such as lacking geolocation tracking capabilities due to a lack of integrated communication interfaces and/or devices, whereas an associated mobile device 106 may include the ability to connect to additional networks in comparison to the computing device 104 in view of the potential availability of an increased number of such communication interfaces and/or devices being integrated into the mobile device 106 and associated with general use thereof. However, it should generally be understood that either of the computing device 104 or the mobile device 106 may include any of the communication interfaces and/or devices as described hereinafter regardless of which type of device 104, 106 is referenced hereinafter in describing the present invention.

Furthermore, the user device, referring to either or both of the computing device 104 and the mobile device 106, may be or include a workstation, a server, or any other suitable device, including a set of servers, a cloud-based application or system, or any other suitable system, adapted to execute, for example any suitable operating system, including Linux, UNIX, Windows, macOS, iOS, Android and any other known operating system used on personal computers, central computing systems, phones, and other devices.

The user 110 can be an individual, a group, or any entity in possession of or having access to the user device, referring to either or both of the mobile device 104 and computing device 106, which may be personal or public items. Although the user 110 may be singly represented in some drawings, at least in some embodiments according to these descriptions the user 110 is one of many such that a market or community of users, consumers, customers, business entities, government entities, clubs, and groups of any size are all within the scope of these descriptions.

The user device 104, 106, as illustrated with reference to the exemplary mobile device 106 of FIG. 1, includes components including at least one of each of a processing device 120 and a memory device 122 for processing use, such as random access memory (RAM) and/or read-only memory (ROM). The illustrated mobile device 106 further includes a storage device 124 including at least one of a non-transitory storage medium, such as a microdrive, for long-term, intermediate-term, and short-term storage of computer-readable instructions 126 for execution by the processing device 120. For example, the instructions 126 can include instructions for an operating system and various applications or programs 130, of which the illustrated application 132 is represented as a particular example. The storage device 124 can store various other data items 134, which can include, as non-limiting examples, cached data, user files such as those for pictures, audio and/or video recordings, files downloaded or received from other devices, and other data items that are preferred by the user or that are required or related to any or all of the applications or programs 130.

The memory device 122 is operatively coupled to the processing device 120. As used herein, memory includes any computer readable medium to store data, code, or other information. The memory device 122 may include volatile memory, such as volatile Random Access Memory (RAM) including a cache area for the temporary storage of data. The memory device 122 may also include non-volatile memory, which can be embedded and/or may be removable. The non-volatile memory can additionally or alternatively include an electrically erasable programmable read-only memory (EEPROM), flash memory or the like.

The memory device 122 and storage device 124 can store any of a number of applications which comprise computer-executable instructions and code executed by the processing device 120 to implement the functions of the user devices 104, 106 described herein. For example, the memory device 122 may include such applications as a conventional web browser application and/or a mobile P2P payment system client application. These applications also typically provide a graphical user interface (GUI) on the display 140 that allows the user 110 to communicate with the mobile device 106, and, for example a mobile banking system, and/or other devices or systems. In one embodiment, when the user 110 decides to enroll in a mobile banking program, the user 110 downloads or otherwise obtains the mobile banking system client application from a mobile banking system, for example enterprise system 200, or from a distinct application server. In other embodiments, the user 110 interacts with a mobile banking system via a web browser application in addition to, or instead of, the mobile P2P payment system client application.

The processing device 120, and other processors described herein, generally include circuitry for implementing communication and/or logic functions of the mobile device 106. For example, the processing device 120 may include a digital signal processor, a microprocessor, and various analog to digital converters, digital to analog converters, and/or other support circuits. Control and signal processing functions of the mobile device 106 are allocated between these devices according to their respective capabilities. The processing device 120 thus may also include the functionality to encode and interleave messages and data prior to modulation and transmission. The processing device 120 can additionally include an internal data modem. Further, the processing device 120 may include functionality to operate one or more software programs, which may be stored in the memory device 122, or in the storage device 124. For example, the processing device 120 may be capable of operating a connectivity program, such as a web browser application. The web browser application may then allow the mobile device 106 to transmit and receive web content, such as, for example, location-based content and/or other web page content, according to a Wireless Application Protocol (WAP), Hypertext Transfer Protocol (HTTP), and/or the like.

The memory device 122 and storage device 124 can each also store any of a number of pieces of information, and data, used by the user device and the applications and devices that facilitate functions of the user device, or are in communication with the user device, to implement the functions described herein and others not expressly described. For example, the storage device may include such data as user authentication information, etc.

The processing device 120, in various examples, can operatively perform calculations, can process instructions for execution, and can manipulate information. The processing device 120 can execute machine-executable instructions stored in the storage device 124 and/or memory device 122 to thereby perform methods and functions as described or implied herein, for example by one or more corresponding flow charts expressly provided or implied as would be understood by one of ordinary skill in the art to which the subject matters of these descriptions pertain. The processing device 120 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof. In some embodiments, particular portions or steps of methods and functions described herein are performed in whole or in part by way of the processing device 120, while in other embodiments methods and functions described herein include cloud-based computing in whole or in part such that the processing device 120 facilitates local operations including, as non-limiting examples, communication, data transfer, and user inputs and outputs such as receiving commands from and providing displays to the user.

The mobile device 106, as illustrated, includes an input and output system 136, referring to, including, or operatively coupled with, user input devices and user output devices, which are operatively coupled to the processing device 120. The user output devices include a display 140 (e.g., a liquid crystal display or the like), which can be, as a non-limiting example, a touch screen of the mobile device 106, which serves both as an output device, by providing graphical and text indicia and presentations for viewing by one or more user 110, and as an input device, by providing virtual buttons, selectable options, a virtual keyboard, and other indicia that, when touched, control the mobile device 106 by user action. The user output devices include a speaker 144 or other audio device. The user input devices, which allow the mobile device 106 to receive data and actions such as button manipulations and touches from a user such as the user 110, may include any of a number of devices allowing the mobile device 106 to receive data from a user, such as a keypad, keyboard, touch-screen, touchpad, microphone 142, mouse, joystick, other pointer device, button, soft key, and/or other input device(s). The user interface may also include a camera 146, such as a digital camera.

Further non-limiting examples include, one or more of each, any, and all of a wireless or wired keyboard, a mouse, a touchpad, a button, a switch, a light, an LED, a buzzer, a bell, a printer and/or other user input devices and output devices for use by or communication with the user 110 in accessing, using, and controlling, in whole or in part, the user device, referring to either or both of the computing device 104 and a mobile device 106. Inputs by one or more user 110 can thus be made via voice, text or graphical indicia selections. For example, such inputs in some examples correspond to user-side actions and communications seeking services and products of the enterprise system 200, and at least some outputs in such examples correspond to data representing enterprise-side actions and communications in two-way communications between a user 110 and an enterprise system 200.

The user device 104, 106 may also include a positioning device 108, which can be a global positioning system (GPS) device that is configured for utilization by a corresponding positioning system to determine a location of the user device 104, 106. For example, the positioning device 108 may include a GPS transceiver. In some embodiments, the positioning device 108 may include an antenna, transmitter, and receiver. For example, in one embodiment, triangulation of cellular signals may be used to identify the approximate location of the user device 104, 106. In other embodiments, the positioning device 108 includes a proximity sensor or transmitter, such as an RFID tag, that can sense or be sensed by devices known to be located proximate a merchant or other location to determine that the user device 104, 106 is located proximate these known devices.

In the illustrated example, a system intraconnect 138, connects, for example electrically, the various described, illustrated, and implied components of the mobile device 106. The intraconnect 138, in various non-limiting examples, can include or represent, a system bus, a high-speed interface connecting the processing device 120 to the memory device 122, individual electrical connections among the components, and electrical conductive traces on a motherboard common to some or all of the above-described components of the user device. As discussed herein, the system intraconnect 138 may operatively couple various components with one another, or in other words, electrically connects those components, either directly or indirectly—by way of intermediate component(s)—with one another.

The user device, referring to either or both of the computing device 104 and the mobile device 106, with particular reference to the mobile device 106 for illustration purposes, includes a communication interface 150, by which the mobile device 106 communicates and conducts transactions with other devices and systems. The communication interface 150 may include digital signal processing circuitry and may provide two-way communications and data exchanges, for example wirelessly via wireless communication device 152, and for an additional or alternative example, via wired or docked communication by mechanical electrically conductive connector 154. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless communication device 152, which can be or include a radio-frequency transceiver, a Bluetooth device, Wi-Fi device, a Near-field communication device, and other transceivers. In addition, GPS services may be included for navigation and location-related data exchanges, whether ingoing and/or outgoing. Communications may also or alternatively be conducted via the connector 154 for wired connections such by USB, Ethernet, and other physically connected modes of data transfer.

The processing device 120 is configured to use the communication interface 150 as, for example, a network interface to communicate with one or more other devices on a network. In this regard, the communication interface 150 utilizes the wireless communication device 152 as an antenna operatively coupled to a transmitter and a receiver (together a “transceiver”) included with the communication interface 150. The processing device 120 is configured to provide signals to and receive signals from the transmitter and receiver, respectively. The signals may include signaling information in accordance with the air interface standard of the applicable cellular system of a wireless telephone network. In this regard, the mobile device 106 may be configured to operate with one or more air interface standards, communication protocols, modulation types, and access types. By way of illustration, the mobile device 106 may be configured to operate in accordance with any of a number of first, second, third, fourth, fifth-generation communication protocols and/or the like. For example, the mobile device 106 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols such as Long-Term Evolution (LTE), fifth-generation (5G) wireless communication protocols, Bluetooth Low Energy (BLE) communication protocols such as Bluetooth 5.0, ultra-wideband (UWB) communication protocols, and/or the like. The mobile device 106 may also be configured to operate in accordance with non-cellular communication mechanisms, such as via a wireless local area network (WLAN) or other communication/data networks.

The communication interface 150 may also include a payment network interface. The payment network interface may include software, such as encryption software, and hardware, such as a modem, for communicating information to and/or from one or more devices on a network. For example, the mobile device 106 may be configured so that it can be used as a credit or debit card by, for example, wirelessly communicating account numbers or other authentication information to a terminal of the network. Such communication could be performed via transmission over a wireless communication protocol such as the Near-field communication protocol.

The mobile device 106 further includes a power source 128, such as a battery, for powering various circuits and other devices that are used to operate the mobile device 106. Embodiments of the mobile device 106 may also include a clock or other timer configured to determine and, in some cases, communicate actual or relative time to the processing device 120 or one or more other devices. For further example, the clock may facilitate timestamping transmissions, receptions, and other data for security, authentication, logging, polling, data expiry, and forensic purposes.

System 100 as illustrated diagrammatically represents at least one example of a possible implementation, where alternatives, additions, and modifications are possible for performing some or all of the described methods, operations and functions. Although shown separately, in some embodiments, two or more systems, servers, or illustrated components may utilized. In some implementations, the functions of one or more systems, servers, or illustrated components may be provided by a single system or server. In some embodiments, the functions of one illustrated system or server may be provided by multiple systems, servers, or computing devices, including those physically located at a central facility, those logically local, and those located as remote with respect to each other.

The enterprise system 200 can offer any number or type of services and products to one or more users 110. In some examples, an enterprise system 200 offers products. In some examples, an enterprise system 200 offers services. Use of “service(s)” or “product(s)” thus relates to either or both in these descriptions. With regard, for example, to online information and financial services, “service” and “product” are sometimes termed interchangeably. In non-limiting examples, services and products include retail services and products, information services and products, custom services and products, predefined or pre-offered services and products, consulting services and products, advising services and products, forecasting services and products, internet products and services, social media, and financial services and products, which may include, in non-limiting examples, services and products relating to banking, checking, savings, investments, credit cards, automatic-teller machines, debit cards, loans, mortgages, personal accounts, business accounts, account management, credit reporting, credit requests, and credit scores.

To provide access to, or information regarding, some or all the services and products of the enterprise system 200, automated assistance may be provided by the enterprise system 200. For example, automated access to user accounts and replies to inquiries may be provided by enterprise-side automated voice, text, and graphical display communications and interactions. In at least some examples, any number of human agents 210, can be employed, utilized, authorized or referred by the enterprise system 200. Such human agents 210 can be, as non-limiting examples, point of sale or point of service (POS) representatives, online customer service assistants available to users 110, advisors, managers, sales team members, and referral agents ready to route user requests and communications to preferred or particular other agents, human or virtual.

Human agents 210 may utilize agent devices 212 to serve users in their interactions to communicate and take action. The agent devices 212 can be, as non-limiting examples, computing devices, kiosks, terminals, smart devices such as phones, and devices and tools at customer service counters and windows at POS locations. In at least one example, the diagrammatic representation of the components of the mobile device 106 in FIG. 1 applies as well to one or both of the computing device 104 and the agent devices 212.

Agent devices 212 individually or collectively include input devices and output devices, including, as non-limiting examples, a touch screen, which serves both as an output device by providing graphical and text indicia and presentations for viewing by one or more agent 210, and as an input device by providing virtual buttons, selectable options, a virtual keyboard, and other indicia that, when touched or activated, control or prompt the agent device 212 by action of the attendant agent 210. Further non-limiting examples include, one or more of each, any, and all of a keyboard, a mouse, a touchpad, a joystick, a button, a switch, a light, an LED, a microphone serving as input device for example for voice input by a human agent 210, a speaker serving as an output device, a camera serving as an input device, a buzzer, a bell, a printer and/or other user input devices and output devices for use by or communication with a human agent 210 in accessing, using, and controlling, in whole or in part, the agent device 212.

Inputs by one or more human agents 210 can thus be made via voice, text or graphical indicia selections. For example, some inputs received by an agent device 212 in some examples correspond to, control, or prompt enterprise-side actions and communications offering services and products of the enterprise system 200, information thereof, or access thereto. At least some outputs by an agent device 212 in some examples correspond to, or are prompted by, user-side actions and communications in two-way communications between a user 110 and an enterprise-side human agent 210.

From a user perspective experience, an interaction in some examples within the scope of these descriptions begins with direct or first access to one or more human agents 210 in person, by phone, or online for example via a chat session or website function or feature. In other examples, a user is first assisted by a virtual agent 214 of the enterprise system 200, which may satisfy user requests or prompts by voice, text, or online functions, and may refer users to one or more human agents 210 once preliminary determinations or conditions are made or met.

A computing system 206 of the enterprise system 200 may include components such as, at least one of each of a processing device 220, and a memory device 222 for processing use, such as random access memory (RAM), and read-only memory (ROM). The illustrated computing system 206 further includes a storage device 224 including at least one non-transitory storage medium, such as a microdrive, for long-term, intermediate-term, and short-term storage of computer-readable instructions 226 for execution by the processing device 220. For example, the instructions 226 can include instructions for an operating system and various applications or programs 230, of which the application 232 is represented as a particular example. The storage device 224 can store various other data 234, which can include, as non-limiting examples, cached data, and files such as those for user accounts, user profiles, account balances, and transaction histories, files downloaded or received from other devices, and other data items preferred by the user or required or related to any or all of the applications or programs 230.

The computing system 206, in the illustrated example, includes an input/output system 236, referring to, including, or operatively coupled with input devices and output devices such as, in a non-limiting example, agent devices 212, which have both input and output capabilities.

In the illustrated example, a system intraconnect 238 electrically connects the various above-described components of the computing system 206. In some cases, the intraconnect 238 operatively couples components to one another, which indicates that the components may be directly or indirectly connected, such as by way of one or more intermediate components. The intraconnect 238, in various non-limiting examples, can include or represent, a system bus, a high-speed interface connecting the processing device 220 to the memory device 222, individual electrical connections among the components, and electrical conductive traces on a motherboard common to some or all of the above-described components of the user device.

The computing system 206, in the illustrated example, includes a communication interface 250, by which the computing system 206 communicates and conducts transactions with other devices and systems. The communication interface 250 may include digital signal processing circuitry and may provide two-way communications and data exchanges, for example wirelessly via wireless device 252, and for an additional or alternative example, via wired or docked communication by mechanical electrically conductive connector 254. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless device 252, which can be or include a radio-frequency transceiver, a Bluetooth device, Wi-Fi device, Near-field communication device, and other transceivers. In addition, GPS (Global Positioning System) may be included for navigation and location-related data exchanges, ingoing and/or outgoing. Communications may also or alternatively be conducted via the connector 254 for wired connections such as by USB, Ethernet, and other physically connected modes of data transfer.

The processing device 220, in various examples, can operatively perform calculations, can process instructions for execution, and can manipulate information. The processing device 220 can execute machine-executable instructions stored in the storage device 224 and/or memory device 222 to thereby perform methods and functions as described or implied herein, for example by one or more corresponding flow charts expressly provided or implied as would be understood by one of ordinary skill in the art to which the subjects matters of these descriptions pertain. The processing device 220 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof.

Furthermore, the computing device 206, may be or include a workstation, a server, or any other suitable device, including a set of servers, a cloud-based application or system, or any other suitable system, adapted to execute, for example any suitable operating system, including Linux, UNIX, Windows, macOS, iOS, Android, and any known other operating system used on personal computer, central computing systems, phones, and other devices.

The user devices, referring to either or both of the mobile device 104 and computing device 106, the agent devices 212, and the enterprise computing system 206, which may be one or any number centrally located or distributed, are in communication through one or more networks, referenced generally as network 258 in FIG. 1.

Network 258 provides wireless or wired communications among the components of the system 100 and the environment thereof, including other devices local or remote to those illustrated, such as additional mobile devices, servers, and other devices communicatively coupled to network 258, including those not illustrated in FIG. 1. The network 258 is depicted as a single network in FIG. 1 for illustrative convenience, but the network 258 may further represent more than one network or more than one type of network while remaining within the scope of the present disclosure. In some embodiments, the network 258 may be or may provide one or more cloud-based services or operations. The network 258 may be or may include an enterprise or secured network, or may be implemented, at least in part, through one or more connections to the Internet. A portion of the network 258 may be a virtual private network (VPN) or an Intranet. The network 258 can include both wired and wireless links, including, as non-limiting examples, 802.11a/b/g/n/ac, 802.20, WiMax, LTE, and/or any other wireless link. The network 258 may include any internal or external network, networks, sub-network, and combinations of such operable to implement communications between various computing components within and beyond the illustrated environment 100. The network 258 may communicate, for example, Internet Protocol (IP) packets, Frame Relay frames, Asynchronous Transfer Mode (ATM) cells, voice, video, data, and other suitable information between network addresses. The network 258 may also include one or more local area networks (LANs), radio access networks (RANs), metropolitan area networks (MANs), wide area networks (WANs), all or a portion of the internet and/or any other communication system or systems at one or more locations.

Two external systems 202 and 204 are expressly illustrated in FIG. 1, representing any number and variety of data sources, users, consumers, customers, business entities, banking systems, government entities, clubs, and groups of any size are all within the scope of the descriptions. In at least one example, the external systems 202 and 204 represent automatic teller machines (ATMs) utilized by the enterprise system 200 in serving users 110. In another example, the external systems 202 and 204 represent payment clearinghouse or payment rail systems for processing payment transactions, and in another example, the external systems 202 and 204 represent third party systems such as merchant systems configured to interact with the user device 106 during transactions and also configured to interact with the enterprise system 200 in back-end transactions clearing processes.

In certain embodiments, one or more of the systems such as the user device 104, 106, the enterprise system 200, and/or the external systems 202 and 204 are, include, or utilize virtual resources. In some cases, such virtual resources are considered cloud resources or virtual machines. Such virtual resources may be available for shared use among multiple distinct resource consumers and in certain implementations, virtual resources do not necessarily correspond to one or more specific pieces of hardware, but rather to a collection of pieces of hardware operatively coupled within a cloud computing configuration so that the resources may be shared, as needed.

The present invention relates to a method of operating the described enterprise system 200 for interacting with a corresponding user 110 when accessing a mobile banking platform and/or digital payment platform via use of an associated user device 104, 106, wherein the mobile banking platform and/or digital payment platform is associated with and/or managed by the enterprise system 200. As utilized hereinafter, the user device 104, 106 may alternatively be referred to more generally as a transceiver by virtue of the manner in which the user device 104, 106 sends and receives communication signals. The mobile banking platform and/or the digital payment platform generally refers to a platform that is accessible to the user 110 via the user device 104, 106 when having an appropriate network connection to the enterprise system 200 and potentially any third-party external systems 202, 204 necessary for carrying out the system and method described herein. The user 110 may access the mobile banking or digital payment software application via the corresponding user device 104, 106 for access to the data regarding the user 110 as maintained by the enterprise system 200, and for accessing any products and/or services offered to the user 110 via the enterprise system 200 and or any third-party external systems 202, 204. The mobile banking software application or the digital payment software application may be representative of the previously described application 132 operable on the user device 104, 106, as one non-limiting example. The mobile banking platform or digital payment platform may be referred to more generally hereinafter as the transceiver platform by virtue of the corresponding software application corresponding to execution of the mobile banking platform/digital payment platform occurring via the transceiver corresponding to the user device 104, 106.

The present invention includes the use of a digital payment software application that is either provided as a stand-alone software application that communicates with a financial institution (such as the enterprise system 200 as shown and described) or that is provided as an aspect of a mobile banking software application managed by a financial institution (such as the enterprise system 200 as shown and described) that includes the same basic features as the stand-alone digital payment software application. For example, where the user 110 is a customer of the enterprise system 200 and has an active account therewith, the same services provided by the stand-alone digital payment software application may be accessible to the user 110 when navigating the mobile banking software application associated with the enterprise system 200 following a successful account login that verifies the identity and credentials of the instantaneous user 110. The accessing of such features during the navigation of the mobile banking software application provides the benefit in that any financial accounts associated with both the user 110 and the enterprise system 200, such as a checking account and/or a savings account of the user 110 that is/are managed and maintained by the enterprise system 200, may be readily accessed by the user 110 when attempting to make or receive a payment typical of the use of such a digital payment software application. In contrast, the use of the stand-alone digital payment software application may require the user 110 to provide additional information in confirming the identity of the user 110 and/or in accessing any financial accounts of the user 110 that are associated with the enterprise system 200 as shown and described, such as requiring additional information regarding the bank accounts of the user 110 maintained with the enterprise system 200, such as appropriate routing numbers or the like.

It is generally assumed hereinafter that the same features of the stand-alone digital payment software application may be accessible via use of the mobile banking software application having the digital payment feature, unless specified otherwise. For brevity, the use of the digital payment feature, regardless of which software application is utilized in accessing the described features, is typically referred to as the use of a digital payment platform hereinafter, wherein it is also assumed that the digital payment platform is being navigated via the use of the mobile device 106 having the capabilities and features described herein, and especially via the use of a mobile device 106 having at least one positioning device 108 for determining a geographic location of the mobile device 106, such as the instantaneous GPS coordinates of the mobile device 106. As such, the examples presented hereinafter generally refer to the mobile device 106 in the absence of reference to the computing device 104, although the computing device 104 may also be utilized in the context of the present invention where the geographic location of the computing device 104 is able to be determined via an associated positioning device 108 or positioning methodology configured to utilization via the computing device 104, such as tracking the IP address of an associated network communicatively coupled to the computing device 104.

The digital payment platform is also described hereinafter as being “interacted with” by the user 110 during navigation thereof. It should be understood that such interactions may refer to any suitable actions of the user 110 capable as acting as an input to the corresponding user device 104, 106, such as a corresponding touch screen interaction, voice activated command, interaction with a connected device (joystick, keyboard, mouse, etc.), or the like, as the circumstances may warrant. Such interactions are generally understood to typically correspond to a selection of an identifiable area of the display of the digital payment platform, such as those areas corresponding to a specific image, block of text, or other graphical representation, which in turn redirects the platform to change the data instantaneously displayed to the user 110 via a reconfiguration of the corresponding graphical user interface and/or causes the digital payment platform to perform a function in accordance with the selected interactive area of the display. For example, navigation of the digital payment platform may be executed on the mobile device 106 having the described display 140 acting as the graphical user interface thereof and the interactions with the display 140 may be associated with touching the display 140 at the position(s) of the described interactive areas.

As mentioned hereinabove, each of the users 110 described herein may be a person or entity acting as a customer or client of the enterprise system 200 that utilizes products and/or services from the enterprise system 200 as defined herein, or may otherwise be a person or entity having an established relationship with the enterprise system 200 such that the enterprise system 200 has access to the necessary personal data regarding each of the participating users 110 for making the determinations or performing the functions described hereinafter. The relationship present between the enterprise system 200 and a corresponding user 110 may include the user 110 having a user account with the enterprise system 200 wherein certain actions of the user 110, actions of the enterprise system 200, and/or interactions between the enterprise system 200 and the user 110 may be monitored and recorded by the computing system 206 of the enterprise system 200. Such data of each of the users 110 of the enterprise system 200 may be in the form of the data 234 stored to the storage device 224 of the computing system 206 as utilized for carrying out the functions of the digital payment platform as described herein. The data 234 may originate from various different sources including the recorded interactions of the user 110 with the enterprise system 200 and/or the recorded interactions of the user 110 with one or more third-party and external sources or systems, which may be representative of the previously disclosed external systems 202, 204.

The user account of each corresponding user 110 may refer to a primary or umbrella account of the user 110 from which data corresponding to various additional or subaccounts is accessible during navigation of the digital payment platform. For example, upon providing the necessary login credentials to access the corresponding user account via the digital payment platform, the logged-in user 110 may then be able to access each of a variety of different financial accounts or subaccounts maintained by the enterprise system 200 and associated with the user 110. As one non-limiting example, the user account of the user 110 may include access to each of a checking account and a savings account, each of which is maintained or monitored in some form by the enterprise system 200 and associated with the user 110. However, the user account may include access to any form of financial account including a record of financial transactions associated with the financial account, such as debits, credits, or transfers between accounts, among other possible transactions. Each transaction of a corresponding financial account may be associated with certain data, such as a corresponding monetary amount and/or date of transaction, by which such transactions may be appropriately categorized or otherwise sorted.

The examples provided hereinafter generally correspond to the types of transactions that would be expected to occur when managing a checking account or savings account associated with the user 110, wherein various purchases, payments, and transfers of funds are typical actions taken in managing such accounts. However, it should be readily apparent that the same general concepts described herein may be applied to any alternative financial accounts whereby money may be deposited or withdrawn when receiving or making an electronic payment without necessarily altering the scope of the present invention.

The digital payment platform of the present invention beneficially includes a security feature wherein the location of the recipient (payee) of the transferred funds is discovered and/or otherwise determined by the computing system 206 responsible for managing the digital payment platform in order to inform the sender (payer) of the funds (typically corresponding to the user 110 as identified herein) of any relevant information regarding the location of the recipient that may indicate an erroneous or fraudulent transaction is about to occur, such as the sender discovering that the recipient is not located in close proximity to the sender, or that the recipient is otherwise not located geographically in accordance with the beliefs or impressions of the sender, as may be based on false or incorrect information shared by the recipient. The present invention requires the sharing of a location of the user device 104, 106 (with the mobile device 106 acting as the described transceiver in most circumstances) being instantaneously utilized by the recipient with the computing system 206 of the enterprise system 200, with such sharing occurring in order to determine whether the location of the user device 104, 106 of the recipient is suspicious and/or otherwise unexpected or problematic in some respect. In some circumstances, the present invention may further include the sharing of a location of the user device 104, 106 of the sender of the funds with the computing system 206 of the enterprise system 200 in order to further determine a relative positioning of the sender and the recipient, such as determining an instantaneous distance present between the devices of the sender and the recipient, or a common geographic boundary in which both devices are or are not present. The present invention accordingly requires at least the permission of the recipient in sharing the recipient's device location and potentially the additional permission of the sender in sharing the sender's device location, depending on the information that is to be communicated to the sender for allowing the sender to ascertain whether the transaction being facilitated by the sender is legitimate, non-fraudulent, and in accordance with the desires of the sender.

The process of accessing the digital payment platform via use of an associated mobile banking software application may generally occur as follows with respect to the user 110 as a sender of funds to a corresponding recipient. First, upon opening the mobile banking software application of the enterprise system 200 via a corresponding user device 104, 106 (assumed to be the mobile device 106 hereinafter), the user 110 may input the necessary credentials for successfully logging into the account of the user 110, which may include multi-factor authentication for the prevention of fraudulent log-ins. The multi-factor authentication may include multiple steps including the mobile device 106 scanning a fingerprint of the user 110, the camera of the mobile device 106 visually recognizing the user 110, and/or the sending of a one-time password (OTP) to the mobile device 106 that is subsequently entered when prompted by the mobile banking software application, as non-limiting examples.

Once successfully logged in, the user 110 may select an option to transfer funds or make a payment, which may then prompt the user 110 to select the type of transaction that is to occur. The selectable types of transactions may relate to transferring money between different accounts of the user 110 managed by the enterprise system 200 (such as between the checking, savings, and/or credit card accounts of the user 110 that are associated with the enterprise system 200), paying other bills or the like that are associated with third-parties, and the use of what has been described as the digital payment platform for sending money to or receiving money from other parties similarly utilizing such a digital payment platform on another respective (mobile) device acting as an appropriate transceiver.

Upon selecting to utilize the digital payment platform as the means of completing a transaction, the user 110 may then be prompted on whether the user 110 would like to send money to another party or request receipt of money from another party. In the present examples, it is assumed that the user 110 is seeking to send money to another party, so the description hereinafter always relates to a transaction where the user 110 is sending money to an independently situated recipient, unless indicated otherwise. The disclosed examples also include description of the steps that must be completed by the recipient to complete such transactions, hence it should be understood that the actions of the recipient may be considered to be the actions of the user 110 where the roles of the sender/receiver of the funds are reversed. Once the selection to send money to another party is selected, the digital payment platform prompts the user 110 to select a recipient of the money to be sent.

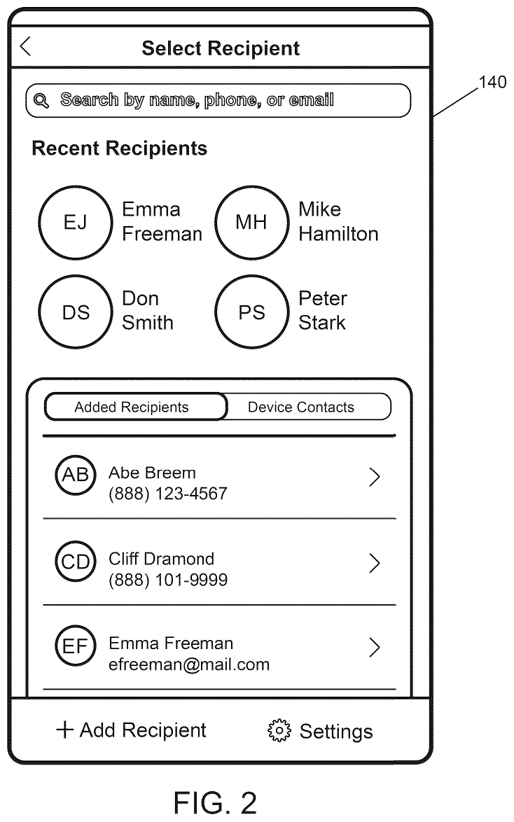

FIG. 2 shows an exemplary representation of the display 140 of the mobile device 106 of the user 110 upon selecting to send money to another party wherein the user 110 is prompted to select the specific recipient of the money to be sent. In the present example, which is non-limiting to the present invention, the user 110 is provided with numerous different methods of finding or identifying the desired recipient, which may include the user 110 selecting a recipient from a list of those recipients that have previously and most recently received money from (or possibly sent money to) the user 110 (those recipients listed under “Recent Recipients”), selecting the recipient from a list of any of the parties the user 110 has previously chosen to add as a recipient during use of the digital payment platform (those recipients listed when selecting the “Added Recipients” tab), or selecting the recipient from the contact list of the user 110 that is stored to the mobile device 106 (those recipients listed when selecting the “Device Contacts” tab), wherein the recipients listed under the Device Contacts tab may not be previously added or recent recipients. The adding of a new recipient may include the user 110 entering a name, username, phone number, or email address that is associated with the desired recipient, wherein the digital payment platform confirms that the added recipient has an account with or has in some way registered to use the digital payment platform in conducting such transactions. The recipients associated with the contact list of the mobile device 106 may be based on any names, usernames, phone numbers, or email addresses that are both stored to the mobile device 106 and associated with a valid registration of the corresponding recipient with the digital payment platform. FIG. 2 also shows a search bar where the user 110 may enter a name, phone number, or email address associated with a registered recipient in order to find the desired recipient, as necessary. The use of the search bar may include the mobile device 106 communicating with the computing system 206 of the enterprise system 200 or an external system 202, 204 associated with another financial institution when locating the desired recipient, such as searching a corresponding database having access to all registered users of the digital payment platform and all identifying information thereof (such as names, usernames, phone numbers, and email addresses).

Although not explicitly illustrated in FIG. 2, the digital payment platform may also include the ability of the user 110 to access the camera 146 of the mobile device 106 in order to scan (view) a visual code (such as a QR-code) that has been generated to identify a specific recipient registered with the digital payment platform. That is, the user 110 may be in the presence of a printed (or otherwise graphically displayed) version of the visual code, or the user 110 may be in the presence of another party (the recipient) accessing the digital payment platform on a separate mobile device while generating the visual code on the display of the separate mobile device such that the camera 146 of the user 110 can scan the generated visual code. The use of such a visual code may be prevalent when conducting in-person transactions at close proximity between two different parties registered with the digital payment platform because such a method may not require either party to enter the identifying information (name, username, phone number, or email address) of the other party to initiate such a transaction. The scanning of the code may lead to the recipient being added to the “Added Recipients” list of the user 110, or may redirect the user 110 to begin the payment process for sending funds to the scanned recipient absent the adding of the recipient to any of the above-described tabs or lists.

FIG. 2 also includes an interactive area where the user 110 may access the user selectable settings of the digital payment platform for customizing the experience of the user 110 during use of the digital payment platform. In the present example, one possible setting that may be accessed and selected may be whether the user 110 would like to give permission (approval) to share the instantaneous location of the mobile device 106 with the computing system 206 of the enterprise system 200 such that the location of the sender may be verified when carrying out the method according to the present invention, such as when determining the distance present between the user 110 as the sender and the corresponding recipient. On the contrary, where funds are being sent to the user 110 as a recipient, selection of the sharing of the instantaneous location of the mobile device 106 of the user 110 may aid the sender of the funds in verifying the location of the user 110 as the recipient according to the presently disclosed method. In other words, the recipient in the following examples may access such a setting as an initial step in completing the receipt of funds according to the present invention.

As explained in greater detail hereinafter, the selectable settings relating to the location verification security feature may also include the selection of what methodology is to be utilized regarding the verification of the location of the recipient where multiple different options are potentially provided, such as whether to report the location of the recipient (or a generalization thereof), whether to provide information regarding the relative position of the recipient in comparison to the sender, such as an assessment of the distance present therebetween, or whether any other geographic relationships indicative of commonalities or dissimilarities are present between the sender and the recipient. Additional selectable settings are described hereinafter when describing the different methodologies that may be utilized in accordance with the present invention. It should also be understood that the selection of the settings described herein may occur via any method of navigating the digital payment platform and may be accessed via a different display or at a different stage of the payment process than shown and described in the following examples, so long as all necessary settings are selected at some point prior to the completion of the corresponding transaction in accordance with the present system and method. It should also be apparent that any such settings may also be selected by the computing system 206 as what may be referred to as default settings in the absence of a corresponding selection by the user 110, depending on the specific embodiment of the present invention. The system and method according to the present invention should also be understood as including the use or implementation of any combination of the settings discussed herein such that the objectives of the present invention may be carried out with respect to at least one full process of completing such a transaction. In other words, the digital payment platform may be provided in the absence of what are described as potential alternative settings hereinafter, such as including only one method of conducting a transaction absent the alternative methods also described herein, as desired.

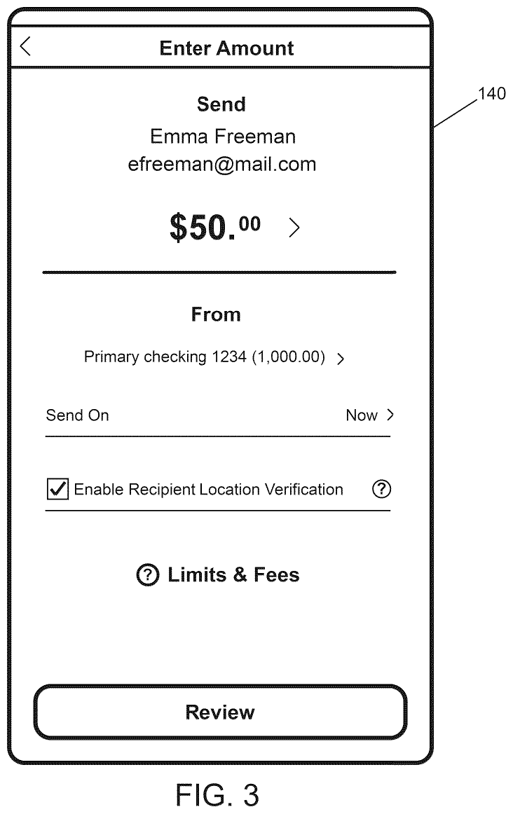

Once a recipient is chosen for receiving the funds according to any of the examples provided above, the user 110 may then be prompted to make various selections such as choosing the amount of money to be sent to the recipient, the source of the money to be sent (such as the savings account or the checking account of the user 110, as managed by the enterprise system 200), and the timing of the money being sent (such as now or at a specific time in the future, such as a specific future date and/or time). FIG. 3 illustrates an exemplary display 140 of the mobile device 106 for entering such information via appropriate interactions with the mobile device 106. FIG. 3 includes the ability to select an interactive area of the display 140 entitled “Review” to move forward in reviewing the information entered in accordance with the transaction about to be completed, such as confirming the identity of the recipient, the amount to be sent, and the account or subaccount from which the money is to be withdrawn.

FIG. 3 also illustrates one example of selecting to utilize the location verification security feature of the present invention. In addition to interactive areas associated with selecting the amount, account origin, and timing of the payment, FIG. 3 illustrates an interactive area for toggling whether or not to utilize the location verification security feature with respect to the instantaneous transaction, which in the present example includes a selectable check box disposed adjacent text stating “Enable Recipient Location Verification.” It should be readily understood that any method of choosing to utilize the location verification security feature, including any method of toggling the selection of the feature, may be employed by the digital payment platform, and that alternative text may also be utilized in describing the outcome of the selection or non-selection of the feature, so long as the feature is able to be selected by the user 110 at some point in time prior to the sending of the payment to the recipient at completion of the transaction. In the present example, the user 110 has selected to utilize the security feature by actively checking the box indicating that recipient location verification will be conducted prior to finalizing the payment to the recipient. As another example, the selection of the location verification security feature being utilized may be made as a selection when the user 110 is reviewing the selectable settings of the digital payment platform as described herein such that the active selection of the location verification security feature is not necessary each instance where the user 110 is attempting to send a payment via the digital payment platform, but is instead the default selection of the user 110 that is enabled with respect to each attempt to send funds according to the digital payment platform until chosen otherwise.

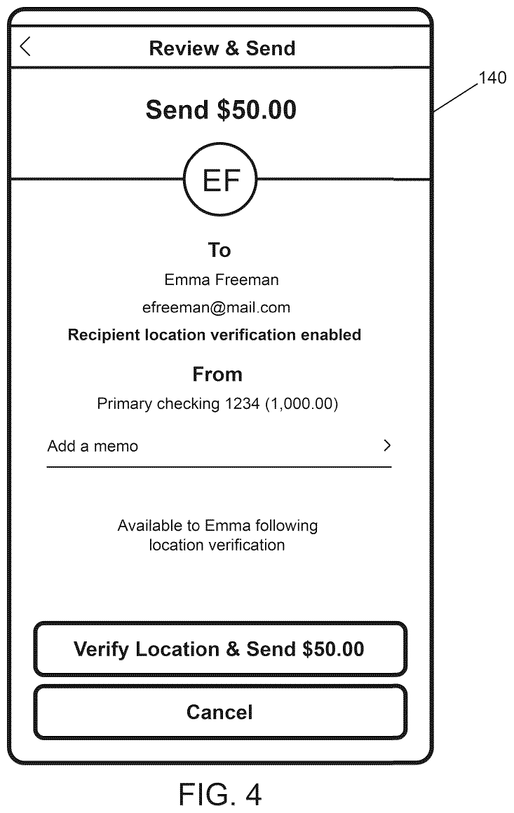

FIG. 4 is an example of the display 140 of the mobile device 106 for reviewing the information described as being entered previously with respect to FIGS. 2 and 3, such as the recipient name, the email address/phone number of the recipient, the account from which the funds are originating, and whether or not the recipient location verification feature has been enabled via any of the above-described methods. FIG. 4 may also optionally include the ability of the user 110 to enter text corresponding to a memo associated with the payment about to be made to better identify the reasoning behind the payment at a future instance. In the example of FIG. 4, an interactive area of the display 140 indicates that the selection thereof will lead to the verification of the location of the recipient and the subsequent sending of the entered monetary amount (assuming the location verification process does not dissuade the sender from completing the transaction), which in the present example is $50.00.

As mentioned previously, the location verification security feature may include various different determinations by the computing system 206 when reporting information to the user 110 for determining whether the user 110 would like to proceed with the payment to the recipient. According to a first method, the digital payment platform may require that each of the mobile device 106 of the user 110 (when acting as the sender) and the corresponding device of the recipient have given permission for the respective device locations to be shared with the computing system 206 in order for the computing system 206 to determine the instantaneous distance present between the sender and the recipient and/or to determine whether the sender and the recipient are or are not located within a common geographic boundary, such as both the sender and the recipient being located within the same city (municipality), county, state, country, continent, zip code, area code, or combinations thereof, as non-limiting examples of geographic commonalities or dissimilarities. According to a second method, the digital payment platform may only require that the location of the device of the recipient be shared with the computing system 206 in order for the computing system 206 to report certain information regarding the determined geographic location of the recipient to the user 110 as sender, such as the city, county, state, country, continent, zip code, area code, or combinations thereof that the recipient is located within, as non-limiting examples.

The instantaneous location of each associated device 104, 106 having given permission for location sharing may preferably be based on the positioning device 108 of each associated device being the previously described GPS transceiver as is most commonly found in the implementation of the user device 104, 106 as the mobile device 106. As another example, the positioning device 108 may rely upon the triangulation of cellular signals to identify the approximate location of the associated device 104, 106 where cellular service is accessible via the corresponding device 104, 106, which may once again be more commonly found in the implementation of the user device 104, 106 as the mobile device 106. As a final example, it is also conceivable that each device may determine the geographic location associated with an IP address of a network in communication with the associated user device 104, 106, although such a method is generally less reliable in accessing the location of the corresponding user device 104, 106 with respect to certain circumstances. For example, it is known that different internet service providers utilize different methodologies of assigning IP addresses and/or of updating publicly available resources regarding the geographic location associated with certain IP addresses following a change thereto, which can significantly alter the reliability of such geographic location determining processes. It is also known that different wireless networks broadcast different signals and/or information than others in a manner rendering the geolocation of certain IP addresses as more precise, accurate, or reliable in comparison to others, such as certain Wi-Fi access points broadcasting data in addition to the IP address of the associated network that can be used to improve the accuracy of the geolocation of the Wi-Fi network, such as broadcasting the GPS-based location of one or more mobile devices 106 in signal communication with the Wi-Fi network, thereby improving the accuracy and precision of the use of an IP address to that approaching the direct use of a GPS transceiver of an associated mobile device 106. The use of the GPS transceiver may thus be the preferable form of the positioning device 108 associated with each user device 104, 106 when implementing the present invention due to the accuracy and precision thereof in comparison to the other described methods.

Due to the lack of precise/accurate location often associated with such methods, the use of cellular triangulation or tracking of the geolocation of an IP address as the positioning device 108 or positioning methodology may also result in the need to assign a nominal location to one or both of the devices 104, 106 relying on such devices 108 or methodologies. For example, if the recipient is determined to be within a certain geographic boundary without the ability to determine a more specific location of the recipient therein (such as being unable to determine the GPS coordinates thereof), then the location of the recipient may be associated with a nominal point position representing the geographic boundary within which the recipient is located, such as a central point or predetermined relevant point associated with the boundary of a city, as one non-limiting example. In some circumstances, the nominal point may be based on a geographic location that is associated in some way with the internet service provider utilized by the one of the user devices 104, 106 for which a location is being determined, such as the reported location of the IP address of the user device 104, 106 being that of a facility or network of the internet service provider that is common to a plurality of different user devices 104, 106 routing information via such an internet service provider. It is assumed hereinafter that the present invention utilizes what is considered to be the most reliable, and/or accurate, and/or precise methodology that is available with respect to each associated user device 104, 106 for making the determinations described herein, which may include the use of a combination of different methodologies with respect to the sender and the recipient, as needed.

Referring again to the first method described above where the locations of both the sender and the recipient are determined and then considered by the computing system 206, the calculating of the distance present between the sender and the recipient may be determined by the computing system 206 based on a comparison of the known location (preferably GPS coordinates) of the respective devices of each of the sender and the recipient. Where a combination of positioning methodologies are utilized, such a comparison may include the use of GPS coordinates associated with one of the associated devices 104, 106 and the use of the above-described nominal point position coordinates associated with the other of the associated devices 104, 106, as needed depending on the availability of each methodology with respect to each such device 104, 106. The present invention may also include the use of the nominal point coordinates with respect to each of the associated devices 104, 106, which may result in the same position being determined with respect to both of the associated devices 104, 106 where the same nominal position is assigned to each of the devices 104, 106 based on the specific circumstances.

The calculated distance may be utilized in reporting various different forms of information to the user 110 as sender when utilizing the location verification security feature. According to one example, the distance present between sender and recipient may be reported to the sender as some form of a range of distance values, such as reporting that the recipient is between 0 and 100 ft away (less than 100 ft away), between 0 and 500 feet away (less than 500 ft away), between 5 and 10 miles away, between 10 and 20 miles away, over 100 miles away, and so forth, as non-limiting examples of possible ranges of values. The use of a range of values may be preferable in reporting the determined distance over the use of a specific distance value to avoid circumstances where the sender could potentially identify the exact location of the recipient by utilizing the known distance present between the sender and recipient, and especially in circumstances where multiple location verifications could be employed by the sender from different locations to triangulate the exact location of the recipient in a manner compromising the privacy of the recipient. However, despite the disadvantage of the reporting of an exact distance with respect to privacy and/or security of the recipient, such a specific distance value may conceivably be utilized by the present invention where the recipient approves of the reporting of such a specific value to the sender, as desired. As another example, rather than utilizing a range of distance values or a specific distance value, the computing system 206 may report the relative position of the recipient via appropriate reporting language, such as stating that the recipient is “in close proximity” to the sender, or alternatively that the recipient “is at a great distance” from the sender. Where nominal point positions are utilized for both the sender and the recipient that correspond to the same location, language may be presented to disclose this fact, such as reporting that both associated devices 104, 106 are utilizing a common location associated with both devices 104, 106 sharing the same internet service provider or the like. Any language for communicating the relationship present between the sender and the recipient for informing the sender of the circumstances associated with the instantaneous transaction may be utilized without necessarily departing from the scope of the present invention.

The use of the location of both the sender and the recipient according to the first method may also be utilized in determining any other relevant relationships present between the sender and the recipient for informing the sender regarding the circumstances of the transaction, such as determining whether the sender and the recipient are or are not located within the common geographic boundary as mentioned above. Such a circumstance may include the computing system 206 determining a classification of the location (GPS coordinates) of each of the sender and the recipient via reference to a data base including such information, such as correlating the determined coordinates of the sender/recipient to a position known to be within a geographic boundary, such as the determined coordinates being disposed within the borders of a city, county, state, country, continent, zip code, area code, or combinations thereof. The computing system 206 can accordingly report any commonalities or dissimilarities present between the sender and the recipient to the sender in informing the sender of the instantaneous circumstances of the recipient. For example, the sender may be informed that the recipient is within the same city, county, state, country, continent, zip code, area code, or combinations thereof as the sender, or that such a relationship is not present between the sender and the recipient, in aiding the sender in determining whether the transaction is occurring as expected by the sender.

Although potentially not preferable from a privacy or security standpoint with respect to certain circumstances, the present invention may also utilize a mapping of the positions of each of the sender and the recipient in informing the sender of the circumstances associated with the recipient during the location verification process. For example, a visually viewable map image (not shown herein) may be generated indicating a position of each of the sender and the recipient, which is then able to be reviewed by the sender via the mobile device 106 thereof at a time prior to finalizing the sending of the funds to the recipient. Such a map may be sent to the sender via text message (short message service), push notification, email, or an applicable feature of the mobile banking platform or digital payment platform. Again, the sharing of such specific information regarding the specific location of the recipient may require the recipient providing additional permissions for the use of such specific information being reported to the sender, including the computing system 206 providing multiple prompts to the recipient to confirm selection of such a setting.

Referring again to the second method where only the location of the recipient is determined by the computing system 206, the sender may receive information relating to the location of the recipient in similar fashion to the scenarios described above. For example, the sender may be informed of the city, county, state, country, continent, zip code, area code, or combinations thereof that the recipient is currently located within, or may in limited circumstances provide a map image showing the specific location of the recipient to the sender. In still other embodiments, it is conceivable that a map image may be generated that shows an area of possible positions of the recipient in accordance with aspects of both of the examples mentioned above, such as illustrating within the map image the area bounded by the geographic boundary in question to aid the sender in determining whether the actual geographic boundary corresponds to the beliefs of the sender, such as confirming that a specific position known to the sender is in fact within the city limits of a city associated with the recipient.

The digital payment platform of the present invention may be configured to utilize any one of the previously described forms of information, as determined by any of the previously described methodologies, while remaining within the scope of the present invention. In some embodiments, the digital payment platform may utilize only one specific methodology, such as exclusively reporting information relating to the distance present between the sender and the recipient, or exclusively reporting information relating to the location of the recipient being within a specific geographic boundary. In other embodiments, the digital payment platform may utilize a combination of the described methodologies, such as reporting a range value corresponding to the distance present between the sender and the recipient as well as information regarding the presence of the recipient within a specific geographic boundary. In yet other embodiments, the digital payment platform may include the ability of the user 110 to select which of the described methodologies to employ, alone or in combination, such as choosing between reporting a distance present between the sender and the recipient (or information relating to the distance), reporting the presence of the recipient within a geographic boundary, reporting the status of a geographic relationship present between the sender and the recipient (such as the sender and the recipient being located in a same or different city, county, state, country, continent, zip code, area code, or combinations thereof), or a mapping of the location of the recipient, a mapping of the geographic boundary within the recipient is generally located, and/or the relative positioning of the sender and the recipient within the corresponding image. Such selections may thus be provided, with respect to certain embodiments of the present invention, to the user 110 as some of the user selectable settings discussed previously during navigation of the digital payment platform or mobile banking platform associated therewith.

The user 110 may also be provided selectable settings regarding what information and/or how the information is reported to the user 110 when acting as the sender regarding the position of the recipient and/or the relationship(s) present between the sender and the recipient. If information is selected to be reported relating to the distance present between the sender and the recipient, then the user 110 may be able to select different ranges of distances that are reported to the user 110, such as choosing between 5 mile increments (within 5 miles, 5-10 miles away, 15 miles away, etc.), 10 mile increments, 25 mile increments, and so forth, or choosing whether the different ranges of distances are reported numerically or via description (such as reporting that the sender and the recipient are in close proximity to each other according to a previously discussed method). If information is reported regarding the geographic location of the recipient, the user 110 may make selections regarding what information is reported to the user 110 based on the determined location of the recipient, such as whether the user 110 is informed of the name of the city, county, state, country, continent, zip code, or area code of the recipient, or any combinations thereof.

The user 110 may also be presented with selectable settings relating to the conditions under which the user 110 is to be alerted of an unusual circumstance relating to the possibility of fraud occurring and/or the user 110 having made an error in selecting the recipient for payment. For example, the user 110 may select a threshold distance value present between the sender (user 110) and the recipient at which an alert is generated by the computing system 206 to ensure that the user 110 is informed of the unusual circumstance before proceeding, such as specifying that any transactions having the recipient located over 25 miles, 50 miles, 100 miles, etc. from the sender when the verification is occurring are to be flagged to the sender before finalizing the sending of the funds. As another example, the user 110 may be alerted whenever the relationship present between the user 110 and the recipient is considered unusual, such as the recipient being located in a different state or country than the user 110, among other possible alarming geographic relationships that may be discovered by such a method.

The user 110 may also be able to select settings regarding circumstances under which the user 110 automatically approves or rejects the completion of a transaction based on the determinations of the computing system 206 during the location verification process. For example, the user 110 may select a setting that any transaction that takes place where the user 110 is within 1 mile of the recipient is automatically approved and facilitated by the computing system 206, without further review of the user 110 or further action regarding the sending of such funds, upon choosing to send the payment to the recipient when the location verification security feature is activated. As another example, the user 110 may select a setting to automatically cancel the process of sending a payment when the location verification process determines that the recipient is more than a threshold distance value away from the user 110, or where the recipient is located in another geographic boundary than the user 110, such as being within a different country than the user 110.

The user 110 may also make selections regarding what information the user 110, when acting as a recipient of funds, is willing to share with the computing system 206 when location sharing is approved by the user 110. For example, the user 110 may select whether or not the computing system 206 is allowed to report certain information to a sender when the user 110 is alternatively acting as the recipient of a transaction, such as limiting the computing system 206 to only reporting information regarding the geographic boundary that the user 110 is located within while not allowing for information to be reported regarding the distance (or range of distances) present between the sender and the user 110 or the specific point position of the user 110. In other embodiments, the permission for location sharing given by the user 110 may apply to the utilization of any such methods by the digital payment platform, and the recipient may not be given options relating to the permissible information to be shared or reported outside of providing a blanket approval for the computing system 206 to carry out the steps necessary in completing a corresponding location verification process according to any of the variations described herein.

In some embodiments, the user 110, when acting as the sender, may be prompted to make one or more selections of the above described selectable settings each instance that the user 110 is in the process of completing a payment to a recipient with the location verification security feature enabled during the process of initiating and/or completing the transaction, such as prompting the user 110 to select what form of information the user 110 would like reported regarding the location of the recipient following completion of the location verification process. In other embodiments, the user 110 may rely upon any default settings or previously chosen settings to be enacted when the location verification security feature is enabled, and the user 110 may not be prompted regarding any such selections prior to the initiation and/or completion of the location verification process with respect to each recipient.

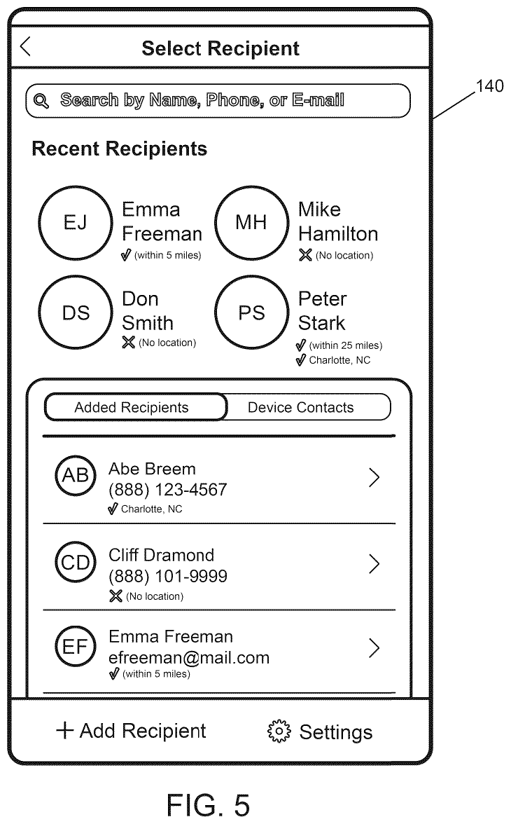

Referring now to FIGS. 5-7, several aspects of the process of requesting and receiving the permission of the recipient to share the location of the device of the recipient in accordance with the described location verification process are disclosed. As utilized herein, it should be understood that general references to the recipient having given the required permission(s) regarding the carrying out of a location verification process refers to the recipient having provided permission(s) with respect to both the sharing of the location of the user device 104, 106 of the recipient with the computing system 206 for making any corresponding determinations as well as the sharing of at least one form of the information regarding the verified location of the recipient, as determined by the computing system 206, with the sender of funds associated with the instantaneous transaction in accordance with the privacy expectations of the recipient in completing such a transaction. Generally speaking, a transaction completed via the location verification process always includes the recipient for which the location sharing permission is being sought actively giving such permission(s) at some point in time prior to the completion of the location verification process and corresponding transaction associated therewith, including at a time prior to the initiation of a specific transaction or as a step occurring during the process of completing a specific transaction, which may be at the prompting of the sender of the funds during such a process.

As noted earlier in describing the settings available to the user 110, the recipient may select a setting independently of the prompting of the recipient by the digital payment platform during the process of completing a transaction, such as the recipient unilaterally accessing the selectable settings of the digital payment platform and proactively selecting the setting(s) regarding whether the location of the recipient is to be shared with the computing system 206 and/or whether any information relating thereto is shared with any senders of money via the digital payment platform. That is, there may be circumstances wherein the recipient selects one or more of the corresponding settings to provide the necessary permissions during application of a location verification process, and this one time and previously occurring selection of settings then remain the default settings with respect to the recipient such that any transactions occurring after such initial selections will not require further prompting or inquiry of the recipient regarding application of the location verification process, and this situation will continue by default until the recipient actively changes the corresponding settings to no longer correspond to such permissions being given for subsequent transactions. Upon the selection of the setting(s) corresponding to the computing system 206 being able to ascertain the location of the recipient and to communicate at least one form of the geographic location data regarding the recipient to a potential sender, each such user/potential recipient having such settings selected as a default may subsequently be displayed alongside such information to a potential sender of funds when seeking the desired recipient via navigation of the digital payment platform.

For example, as shown in FIG. 5, the process of selecting a recipient in a fashion similar to that shown and described with reference to FIG. 2 may further include the distinction that each of the potential recipients is listed along with a reporting of the location information available with respect to each recipient regarding the location sharing permissions provided thereby. The example of FIG. 5 includes several potential recipients listed as having no location reported, which may be indicative of such recipients not having provided such permissions as the default or ongoing setting, or alternatively that the mobile device 106 or other user device 104 associated with such recipients is for whatever reason not available or not in communication with the computing system 206 at the time of accessing such a listing, such as being turned off, communicatively disconnected, or out of communication range. In contrast, the remaining potential recipients are listed with respect to at least one determination regarding the instantaneous location of the corresponding recipient, wherein the different determinations may be based on the selection of different permission settings by the differing recipients with respect to the differing processes described herein. In the current example, three of the recipients are shown as having provided permissions regarding the reporting of a distance range present between the user 110 as sender and each of the respective recipients, such as being within 5 miles or 25 miles, whereas two of the recipients are shown as having provided permissions regarding the reporting of at least one geographic boundary in which each respective recipient is located, such as the city (and corresponding state) in which such recipients are located. One of the exemplary recipients falls into both categories, thereby indicating permissions have been granted for both methodologies to be utilized with respect to the recipient. As stated before, the system and method according to the present invention may include the use or availability of only one such methodology of location verification, hence the illustrated combination of methodologies should not be considered limiting to the present invention. The display of information relating to relative conditions between the sender and the recipient may also require explicit permissions given by the sender when viewing such a list in accordance with the present disclosure.

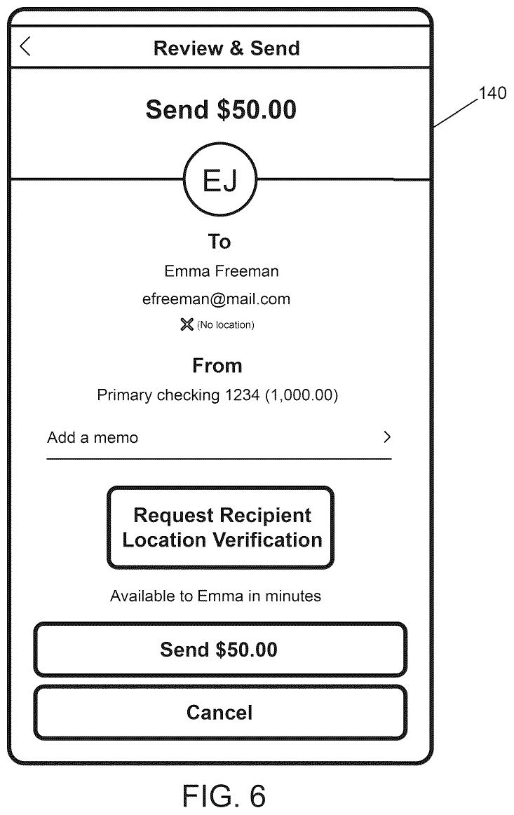

Under circumstances where the recipient has not provided some form of permission ahead of time via selection of such a setting, the system and method according to the present invention may include the user 110 as sender making some form of selection during navigation of the digital payment platform that results in the computing system 206 prompting the recipient to provide the necessary permissions for the appropriate form of location verification process at some point prior to the funds actually being transferred at the completion of the transaction, which may also include such permissions being requested at some point following the sender initiating the transaction process with respect to the recipient. As a slight variation to the example shown with respect to each of FIGS. 3 and 4 where the sender first toggles a selection at one step of the process and then awaits verification as part of a step of approving and sending the funds (after selecting “Verify Location & Send $50.00” in the illustrated example indicative of proceeding with the transaction upon successful location verification), FIG. 6 illustrates an example where the sender may request that the location verification process be successfully completed prior to a selection of any form of approval to move forward with a potential transaction by the sender. Specifically, in FIG. 6 the location verification request is made while reviewing various aspects of the transaction in advance of proceeding to approve the sending of the funds, whereby the example of FIG. 6 is otherwise analogous to that disclosed with regards to the example of FIG. 4. Although not pictured, a similar interactive area regarding such a request for recipient location verification may be present with respect to the exemplary display of FIG. 3 where selections are being made regarding the terms of the transaction (recipient, amount, from which account, etc.) and prior to moving onto the review and send steps associated with the examples of FIGS. 4 and 6. As shown in FIG. 6, the process of establishing the terms of such a transaction may include the lack of permissions being given by the recipient and/or the current unavailability of information regarding the location of the recipient being visible to the sender (shown as an “X” alongside text indicating “No location” has been determined in FIG. 6) and associated with the presence of the interactive area corresponding to the ability to make such a request for initiating the recipient location verification process. It is also conceivable that requests for such permissions with respect to a recipient may be available to the sender as an interactive area associated with each listed recipient when browsing the potential recipients in the manner shown in either of FIG. 2 or 5, as desired, thereby allowing for such a request before details of the transaction have been entered.

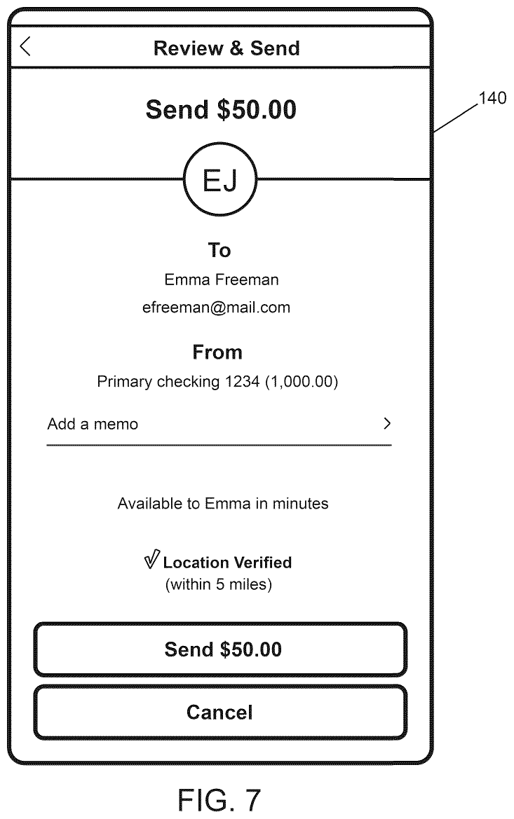

FIG. 7 illustrates an example of the “Review and Send” screen of FIGS. 4 and 6 with the key distinction being that the selected recipient in this example has already provided the necessary permissions such that further prompting of the recipient is not necessary prior to completing the location verification process, where the location information regarding the recipient is already displayed on the screen of FIG. 7 in similar fashion to the display of such information with respect to the listing of the recipients and their location information in FIG. 5. In contrast to FIG. 4, FIG. 7 includes the ability to select an interactive area for sending the funds in the absence of any additional steps relating to the location verification process being necessary as discussed herein.

Regardless of the manner in which the sender selects to initiate the location verification process, such a request is sent by the mobile device 106 of the user 110 to the computing system 206, which leads to the computing system 206 accessing the request and then sending a communication to the user device 104, 106 (mobile device 106 in many circumstances) of the recipient including some form of prompt for the recipient to provide the necessary permissions for location sharing and/or for approving the sending of the corresponding type of location verification information to the sender as a step towards completing the location verification process and thus the corresponding transaction associated therewith. The prompting of the recipient may be provided in any number of forms, including offering to redirect the recipient to an aspect of the digital payment platform executed on the user device 104, 106 thereof having the ability for the recipient to make any selections of any relevant settings related to providing such permissions in similar fashion to the recipient accessing such settings independently of having such a request and resulting prompt sent thereto. Such a process may include the recipient selecting such settings with respect to the present transaction only, such as timing out any such settings selections or limiting the application of such settings beyond the completion of the instantaneous transaction, or may include the recipient making such selections and maintaining such selections as defaults until actively choosing to discontinue such settings via a proactive change thereto. In some implementations, the recipient may be prompted to provide limited selections in comparison to the available selectable settings, such as only requesting that a generalized approval of location sharing be agreed to absent any request for the recipient to address any of the other customizable setting selections described herein.

Depending on what stage the process of completing the transaction is at, the prompting of the recipient to provide additional permissions may include the recipient receiving any relevant information regarding the transaction to aid the recipient in determining if providing such permissions is appropriate to the current circumstances. For example, the request by the sender may include at least some identifying information regarding the sender being sent to the recipient including one or more of the name, username, email address, or phone number of the sender being communicated along with the prompting for permissions such that the recipient is aware of who may receive such location information regarding the recipient. If such a request is made immediately prior to completion of the transaction and following the entry of all relevant information regarding the terms of the transaction, such as following entry of the amount of funds to be transferred and a memo indicating the reasoning for the transaction, then such information may also be communicated to the recipient during the prompting for permissions to give full context to what transaction is associated with the location verification process.

Such a prompting of the recipient may also include the recipient having the option to actively refuse or reject the location sharing request and/or certain aspects thereof where the recipient is uncomfortable with sharing such information, wherein the rejection of certain aspects of the request may include the recipient approving the process in general while also choosing to limit the location sharing process to any combination of the possible variations described hereinabove where the level of detail included in the shared location information regarding the recipient is appropriate with respect to the privacy concerns of the recipient in disclosing such information, such as only utilizing ranges of values of relative distance or geographic boundaries of a size large enough to not specify any specific position of the recipient. The communication to the recipient regarding the request may also indicate that a certain time limit or other limiting factor is associated with the recipient providing or rejecting the necessary permissions before the location verification process is abandoned with respect to the instantaneous transaction.

The sending of such a communication to the recipient may also include the user device 104, 106 of the recipient receiving what could be described as an alert wherein some form of action taken by the user device 104, 106 of the recipient is intended to draw the attention of the recipient to the user device 104, 106 for ensuring that the transaction is able to be completed in a timely fashion and prior to any form of timing out event occurring. As non-limiting examples, such an alert could relate to a graphic appearing on the screen of the corresponding user device 104, 106, an audible sound being played by the user device 104, 106, a vibration of the user device 104, 106, or any other tactile, visual, or auditory method of providing such an alert via such a user device 104, 106. The real time receipt of such an alert as a step in the disclosed process may be critical in quickly completing a time sensitive transaction, such as when funds are being exchanged via the digital payment platform when an in-person exchange of goods or services is occurring and payment is due immediately, or other circumstances where the timeliness of completion of the transaction is necessary.

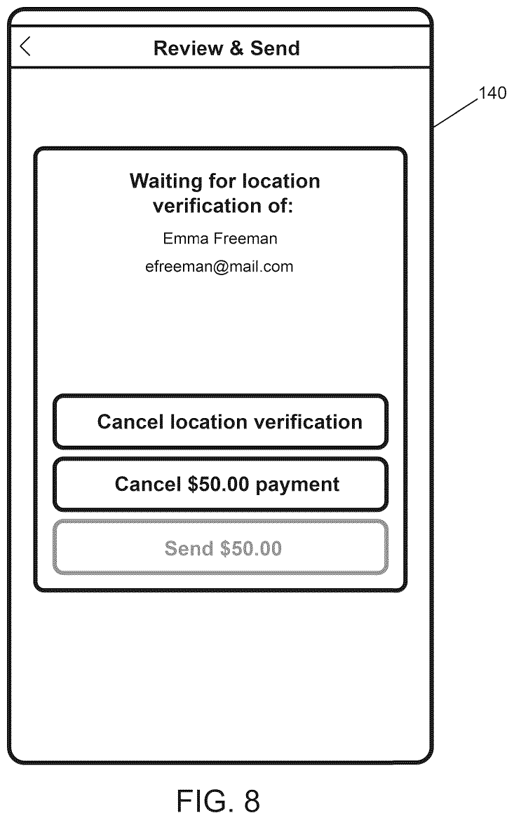

Referring specifically to FIGS. 8-12, various possible screen configurations are shown as may be presented to the sender at various different stages of the location verification process and in reaction to the sender requesting the location verification process with respect to the selected recipient. FIG. 8 shows that the sender may be informed that the location verification process has not yet been completed with one possible explanation being that the recipient has not yet provided the necessary permissions to allow the computing system 206 to make the necessary determinations and then report the relevant information to the sender. However, the example of FIG. 8 also includes the ability of the sender to cancel the location verification process and/or to cancel the transaction more generally when awaiting such permissions and the completion of the processed carried out by the computing system 206.

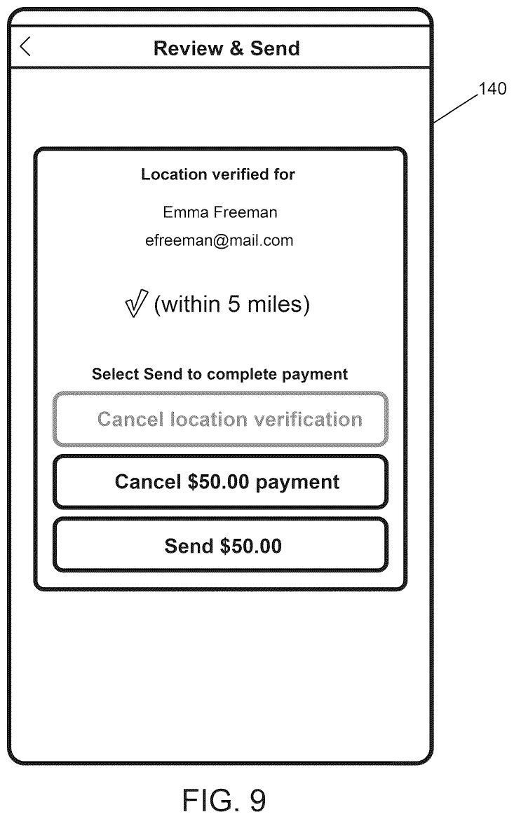

FIG. 9 illustrates an exemplary screen of the sender where the necessary permissions have been provided by the recipient such that the computing system 206 has completed all necessary determinations and has thus reported to the sender the corresponding location information relating to the recipient, which in the illustrated example relates to comparing the locations of the sender and the recipient according to one possible implementation. This example does not include the sender having some form of setting selected wherein completion of the location verification process automatically leads to the sending of the specified funds based on the results of the location verification process meeting the requirements of the sender, such as the recipient being in relatively close proximity thereto (within 5 miles). Instead, the sender is able to choose whether to cancel the payment based on the content of the received information or to alternatively continue with the sending of the funds based on the received information, wherein the determination made by the sender may be based on the expectations of the sender when initiating the location verification process. For example, the information shown in FIG. 9 may lead to an approval to send such funds when the sender is under the impression that the recipient is in fact within 5 miles based on being in the presence of the recipient, or may alternatively lead to the cancelling of the transaction where the sender is under the impression that the recipient is actually located at a great distance indicative of the selected recipient being incorrectly selected or possibly attempting to defraud the sender according to some possible schemes.

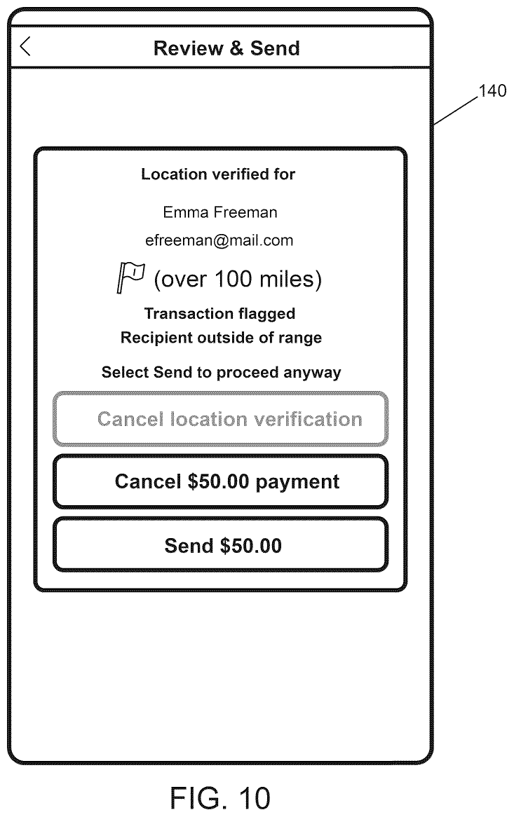

The example shown in FIG. 10 includes completion of the location verification process with the sender having selected a setting indicating that certain information resulting from the process should be flagged where such information is indicative of a potentially incorrect recipient selection or some form of potential fraud perpetrated by the recipient, which in the present example relates to the recipient being discovered to be more than 100 miles away from the sender. The flagging of such an outcome includes the sender being able to then select whether the flagged information is problematic enough to cancel the transaction or whether the sender would still like to complete the transaction, such as where the sender already expected such a result based on knowledge of the expected location of the recipient. It should be apparent that alternative conditions may lead to such a flagging based on the examples provided hereinabove in addition to the illustrated flagging condition of being more than 100 miles away, including any relationship with respect to any methodology being consistent with the need to flag the results of the location verification process.

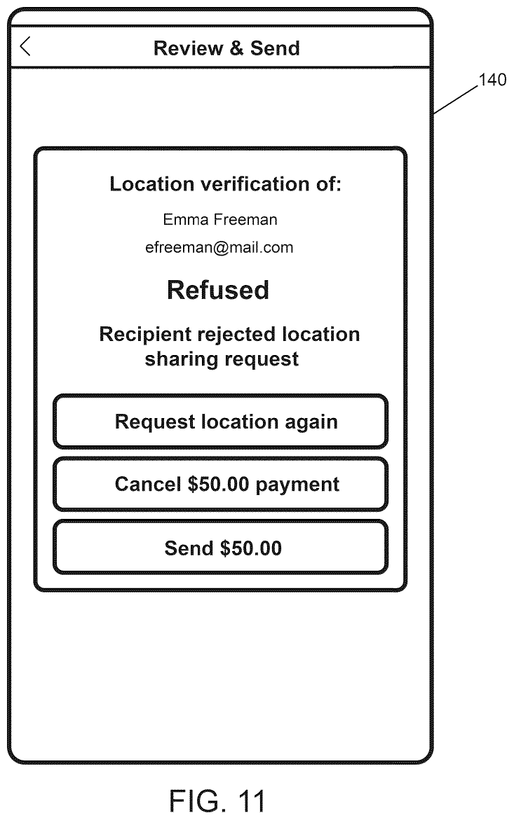

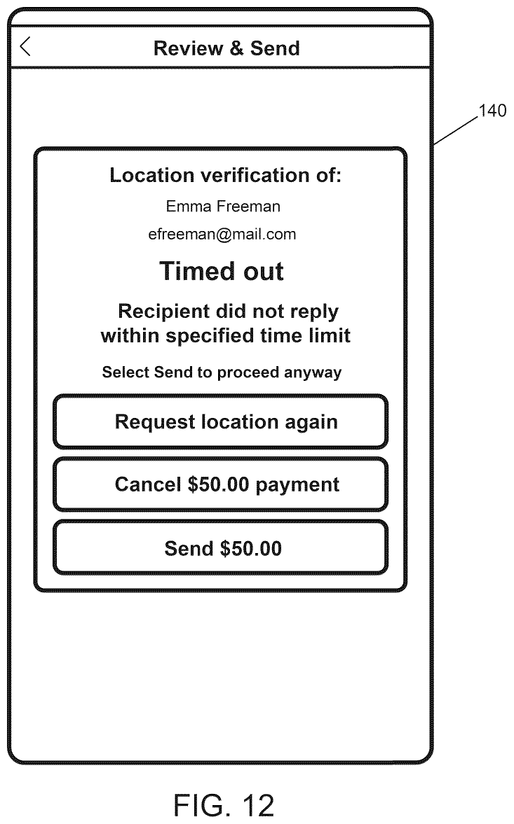

FIGS. 11 and 12 show two possible examples where the location verification process does not get completed and thus relevant location information is not communicated to the sender in accordance with the present system and method. FIG. 11 illustrates an example where the recipient has responded to the prompting of the computing system 206 at the request of the sender to actively disapprove of providing the necessary permissions for completing the location verification process. Such a refusal is shown as being associated with the sender then choosing whether to request the location verification once again, whether to cancel the transaction in view of the location verification refusal, or whether to proceed with the transaction regardless of the refusal of the recipient. FIG. 12 illustrates an example wherein instead of actively rejecting or refusing the location verification process, the recipient has simply not responded to the prompt for providing such permissions within a specified time period following the request of the sender for such location verification. The specified time period may be a setting selected by the sender or may be determined by the computing system 206 according to different implementations of the present invention. The timing out of the location verification process may again be associated with sending another request, canceling the transaction, or going ahead with the transaction absent completion of the location verification process.

In similar fashion to the manner in which the recipient may receive a prompt in conjunction with an alert indicating that a timely action must be taken by the recipient to complete the transaction according to the request of the sender, the sender may likewise be presented with some form of alert via the mobile device 106 thereof at the time that the location information regarding the recipient is communicated thereto, or alternatively when an action or inaction of the recipient leads to the rejection or timing out of the location verification process and the subsequent reporting of such a circumstance to the sender via an appropriate communication such as is disclosed with reference to any of FIGS. 9-12. Additionally, although the communications described as being communicated to a corresponding user device 104, 106 of the sender and/or the recipient are generally shown and described herein as being facilitated by interaction with and/or navigation of the digital payment platform as shown in the exemplary screen displays of FIGS. 9-12, it should be understood that such communications may take alternative pathways for reaching the attention of the sender and/or recipient without departing from the scope of the present invention. For example, the sender and/or recipient may receive communications from the computing system 206 via email notification, text message (short message service) communication, push notification processes, or the like for subsequently redirecting the sender or recipient to an appropriate aspect or screen of the digital payment platform where the actions described herein may then take place. It is also conceivable that certain methods of communicating with the sender and/or the recipient may include permissions being provided to the computing system 206 outside of direct use of the digital payment platform, such as by allowing for such permissions to be provided via appropriate email or text message reply to a corresponding communication generated by such means, as desired.

The disclosed location verification processes accordingly represent a dramatic improvement in the technical field of securing digitally facilitated transactions via the ability of the sender to quickly and easily determine whether an unexpected relationship is present between the sender and the recipient in view of the circumstances presented to the sender when determining whether to conduct the transaction in question. The present invention utilizes the ability to determine location information regarding the recipient, whether directed towards the location of the device 104, 106 of the recipient itself or one of the relationships that may be determined between the locations of the user devices 104, 106 of each of the recipient and the sender, and provide such information for review of the sender as an additional security step for confirming the thoughts and impressions of the sender in deciding to complete or cancel a potential transaction between the sender and the recipient. The computing system 206 utilizes the technical features of each respective user device 104, 106 for determining such location information in a manner that otherwise would not be able to be replicated in the absence of the inclusion of the positioning devices 108 and communication interfaces 150 of the respective devices 104, 106 in conjunction with the actions taken by the computing system 206 in carrying out the location verification processes.

The present system and method thus presents a practical solution to circumstances wherein it is otherwise not possible for the sender to confirm that the account that has been selected as the recipient of the funds is in fact likely to be the correct recipient based on the communicated location information thereabout. The system also takes appropriate actions in response to a determination that a suspect transaction condition is occurring, including the reporting of the relevant information resulting from such determinations in a real-time manner. The reporting of such information may further include the ability to activate certain features of a corresponding user device 104, 106 constituting an alert or warning system for prompt resolution of such concerns following immediate awareness by the sender that a suspect or unusual circumstance has been identified. According to certain embodiments or selectable settings offered to the sender, the system also is capable of automatically taking action based on certain conditions being met or not being met, such as automatically completing or cancelling the completion of such transactions when within predefined parameters or automatically completing or cancelling transactions when not within such predefined parameters, depending on the circumstances. The disclosed system and method is thus practical in application as the most up-to-date and accurate information regarding potential security risks may be automatically communicated to the relevant parties in real time and/or automated processes of the system may be utilized in maintaining the security of such transactions. Additionally, the disclosed system and method can also streamline such processes by allowing the sender to select settings that correspond to bypassing what would otherwise be considered potential security concerns based on inputs from the user 110 regarding circumstances where potential security risks are less likely to be evident or should be disregarded.

Various different examples where such a location verification process may be beneficially utilized are described hereinafter in accordance with the present disclosure. As a first example, the sender can avoid circumstances wherein the sender mistakenly selects the wrong recipient among a listing of possible recipients having similar names, email addresses, phone numbers, or other identifying information utilized by the digital payment platform in identifying the different accounts that are registered for making such transactions via the digital payment platform as a result of the additionally provided location information being capable of indicating such a mistaken selection, such as when the sender mistakenly chooses a distantly located recipient when attempting to make a payment to a local recipient, or vice versa. As another example, the sender may quickly discover that a transaction that has been communicated by the recipient as being critical to fulfilling the terms of some agreement, such as the sender needing to purchase equipment at the request of a potential employer before being able to start employment, unexpectedly involves the transfer of funds to a remote location that has no apparent association with the claimed employer. As another possible example, there may be circumstances where a scammer provides a scannable visual code (QR-code or the like) that is not generated by or shown on the display of the user device 104, 106 of the expected recipient, such as posting such a visual code adjacent a point of sale in the absence of the knowledge of the intended recipient or the sender (such as the seller of a product in a marketplace), in order to cause one or more transactions to be improperly directed to a different account than expected by either the sender or intended recipient of the transaction. Such a circumstance could be avoided by the location of the actual recipient being reported to the sender when the sender is otherwise expecting the device 104, 106 of the intended recipient to be in close proximity or at an expected geographic location.

Particular embodiments and features have been described with reference to the drawings. It is to be understood that these descriptions are not limited to any single embodiment or any particular set of features. Similar embodiments and features may arise or modifications and additions may be made without departing from the scope of these descriptions and the spirit of the appended claims.

What is claimed is:

1. A computing system for remote transceiver interaction, the computing system comprising:
at least one processor;
a communication interface communicatively coupled to the at least one processor; and
a memory device storing executable code that, when executed, causes the processor to:
present, to a first transceiver of a first user, an interface of a transceiver platform managed by the computing system, the interface prompting the first user to select a second user associated with a second transceiver for initiating an interaction between the first user and the second user via the transceiver platform;
determine a geographic location of the second transceiver via reference to a positioning device of the second transceiver; and
automatically perform at least one of the following actions after the determining of the geographic location of the second transceiver associated with the second user:
communicate information regarding the determined geographic location of the second transceiver to the first transceiver prior to prompting the first user to make a selection, via the interface of the transceiver platform, regarding whether to complete the interaction between the first user and the second user via the transceiver platform; or
automatically facilitate or cancel completion of the interaction between the first user and the second user via the transceiver platform based on analysis of the information regarding the determined geographic location of the second transceiver.

2. The computing system of claim 1, wherein the interaction between the first user and the second user via the transceiver platform relates to a monetary transfer from a monetary account of the first user to a monetary account of the second user.

3. The computing system of claim 1, wherein the transceiver platform is a digital payment platform and the monetary account of the first user is associated with a financial entity managing the computing system.

4. The computing system of claim 1, wherein the positioning device of the second transceiver is a GPS device of the second transceiver.

5. The computing system of claim 1, wherein the positioning device of the second transceiver relates to use of a cellular signal associated with the second transceiver.

6. The computing system of claim 1, wherein the executable code, when executed, further causes the processor to prompt the first user, via the first transceiver, to make a selection regarding whether to cause the computing system to determine the geographic location of the second transceiver prior to completion of the interaction between the first user and the second user.

7. The computing system of claim 1, wherein the executable code, when executed, further causes the processor to prompt the second user, via use of the second transceiver, to make a selection regarding the second user providing permission to the computing system to determine the geographic location of the second transceiver via reference to the positioning device thereof.

8. The computing system of claim 7, wherein a selection of the second user to not provide permission to the computing system results in the computing system reporting the selection of the second user to the first user, via the first transceiver, and prior to competition of the interaction between the first user and the second user via the transceiver platform.

9. The computing system of claim 7, wherein the second user failing to make the selection regarding the second user providing permission to the computing system within a predetermined time period results in the computing system reporting the lack of selection of the second user to the first user, via the first transceiver, and prior to completion of the interaction between the first user and the second user via the transceiver platform.

10. The computing system of claim 7, wherein the second user making the selection to provide permission to the computing system prior to the first user selecting the second user for initiating the interaction between the first user and the second user via the transceiver platform results in the information regarding the determined geographic location of the second transceiver being communicated to the first user, via the first transceiver, prior to or during a process of the first user selecting the second user for initiating the interaction between the first user and the second user via the transceiver platform.

11. The computing system of claim 7, wherein the computing system prompting the second user, via use of the second transceiver, to make the selection regarding the second user providing permission to the computing system to determine the geographic location of the second transceiver via reference to the positioning device thereof occurs at the request of the first user via the interface of the transceiver platform.

12. The computing system of claim 1, wherein the information regarding the determined geographic location of the second transceiver relates to a geographic boundary in which the second transceiver is determined to be located.

13. The computing system of claim 12, wherein the geographic boundary relates to one of a municipality, county, state, country, continent, zip code, or area code.

14. The computing system of claim 12, wherein the communicating of the information regarding the determined geographic location of the second transceiver to the first transceiver includes an alert presented to the first user, via the first transceiver, when the geographic boundary that the second transceiver is determined to be located within is not included in a first set of one or more predefined acceptable geographic boundaries and/or is included in a second set of one of more predefined unacceptable geographic boundaries.

15. The computing system of claim 14, wherein the first set of one or more predefined acceptable geographic boundaries and/or the second set of one or more predefined unacceptable geographic boundaries is determined by selection of the first user during navigation of the transceiver platform.

16. The computing system of claim 12, wherein the computing system automatically facilitates completion of the interaction between the first user and the second user via the transceiver platform when the geographic boundary that the second transceiver is determined to be located within is included in a first set of one or more predefined acceptable geographic boundaries and/or is not included in a second set of one of more predefined unacceptable geographic boundaries.

17. The computing system of claim 16, wherein the first set of one or more predefined acceptable geographic boundaries and/or the second set of one or more predefined unacceptable geographic boundaries is determined by selection of the first user during navigation of the transceiver platform.

18. The computing system of claim 12, wherein the computing system automatically cancels completion of the interaction between the first user and the second user via the transceiver platform when the geographic boundary that the second transceiver is determined to be located within is not included in a first set of one or more predefined acceptable geographic boundaries and/or is included in a second set of one of more predefined unacceptable geographic boundaries.

19. The computing system of claim 18, wherein the first set of one or more predefined acceptable geographic boundaries and/or the second set of one or more predefined unacceptable geographic boundaries is determined by selection of the first user during navigation of the transceiver platform.

20. A method of operating a computing system for remote transceiver interaction comprising:
presenting, to a first transceiver of a first user, an interface of a transceiver platform managed by the computing system, the interface prompting the first user to select a second user associated with a second transceiver for initiating an interaction between the first user and the second user via the transceiver platform;
determining a geographic location of the second transceiver via reference to a positioning device of the second transceiver; and
automatically performing at least one of the following actions after the determining of the geographic location of the second transceiver associated with the second user:
communicating information regarding the determined geographic location of the second transceiver to the first transceiver prior to prompting the first user to make a selection, via the interface of the transceiver platform, regarding whether to complete the interaction between the first user and the second user via the transceiver platform; or
automatically facilitating or cancelling completion of the interaction between the first user and the second user via the transceiver platform based on analysis of the information regarding the determined geographic location of the second transceiver.
